(19) United States
(12) Patent Application Publication
(10) Pub. No.: US 2005/0024698 A1
(43) Pub. Date: Feb. 3, 2005

(54) Process for the output of a digital document on an output device

(75) Inventors: Martin Beyer, Bergkamen (DE); Bjorn Seegers, Munster (DE); Klaus Godde, Salzbergen (DE); Francis Lamy, Zollikon (CH)

Correspondence Address: BURNS DOANE SWECKER & MATHIS L L P, POST OFFICE BOX 1404, ALEXANDRIA, VA, 22313-1404, US

(73) Assignee: Logo Beteiligungsges, mbH

(21) Appl. No.: 10/873,235

(22) Filed: Jun. 23, 2004

(30) Foreign Application Priority Data
Jun. 23, 2003 (EP) 03 013 442.3

(51) Int. Cl. H04N 1/60

(52) U.S. Cl. 358/527; 358/518; 358/1.9

(57) ABSTRACT

To provide true color reproduction of documents created by way of a color management free application on an output device, especially a digital electronic projector (beamer), digital documents (D) are, on the output computer (RA) which controls the output device (B), transformed by way of a color management system into the color space of the output device. A program module (PM) is installed on the output computer (RA) in addition to the application software (A), which cooperates with the application software and can access the data of the documents (D) to be output. The program module (PM) includes a color transformation unit (CMM) which, by way of a monitor profile (MP) as source profile and an output device profile (BP) as target profile, transforms the documents (D) into the color space of the output device (B). The transformed documents (D′) are then output by the application software (A) to the output device (B) which reproduces them visually.

### CROSS REFERENCE TO RELATED APPLICATIONS

This application claims priority under 35 U.S.C. §119 to European Application 03 013 442.3 filed in Europe on 23 Jun. 2003, the entire contents of which are hereby incorporated by reference in their entirety.

### FIELD

A process is disclosed for the output of a digital document on an output device controlled by an output computer.

### BACKGROUND

Color management methods and color management systems are generally used in digital color reproduction processes for the improvement of the color trueness. A comprehensive and clear illustration of the background, technologies and applications of color management systems is found in the publication. “Postscriptum on Color Management, Philosophy and Technology of Color Management” of the authors Stefan Brües, Liane May and Dietmar Fuchs, published August 1999 by the company Logo GmbH, a company of the Gretag-Macbeth Group. A further discussion of color management is found, for example, in Chapter 17 “Device-Independent Color Imaging” of the book “Color Appearance Models” of Mark D. Fairchild, first addition, published 1997 by Addison Wesley. Additional discussions are further found in the pertinent publications of the International Color Consortium (ICC).

A Color Management System enables a true color reproduction of an image original in a digital work process which can include an input medium (for example scanner or digital camera) and several output media (for example monitor, digital projector and printer). The original is digitalized with the input medium and the RGB-Values of each image pixel stored in a data file. The RGB-Image can be illustrated on the monitor or by way of a beamer and recalculated into the printer colors for an output on a printer. The true color reproduction is achieved by the use of device profiles and color transformations based on these device profiles.

A device profile describes the color space of an input or output device in that it assigns absolute color values (XYZ or CIELab L*a*b*) to the device specific color values (for example RGB or CMYK) according to the specifications of the CIE (Commission International de l'Eclairage) or other not device specific color values (for example sRGB). A device profile can include diverse color value replacement tables (look up tables) and coefficients of a color space transformation matrix.

For a color true image reproduction, the Color Management System combines the profile of the input medium (source profile) and the profile of the output medium (target profile) and obtains a transfer characteristic therefrom. The Color Management System thereby also carries out an imaging of the color space of the input device onto the color space of the output device. This imaging ensures that all colors can be reproduced on the output medium. The imaging, which means the resealing of the color spaces, is carried out according to different reproduction criteria, the so called Rendering Intents. It is thereby distinguished between the modes “Perceptual” (equal color impression in the image), “Relative Colorimetric”, “Absolute Colorimetric” and “Saturation”, which are defined in document ICC-1:1998-09 of the International Color Consortium (ICC).

An application software can also take the place of the input medium, by which the image original can be produced directly in digital form on a screen. In order that the methods of the Color Management are also applicable in this case, the application software (in the following abbreviated as application) must include a Color Management System, must access profiles and must be able to process them. Such an application is thereby ideally fully ICC-conform so that it can access and use the basic Color Management Functions made available by the operating system of the computer. However, in practice wide spread presentation applications such as, for example, Microsoft PowerPoint or Apple Keynote, are not ICC-conform and at least do not include a color management system or can not access and process profiles. Such applications are in the following referred to as color management free applications. Documents produced with such applications (presentations) therefore normally give a color impression during the presentation with a digital projector (beamer) or upon printing which is often significantly deviated from the color impression on the monitor on which they were produced.

### SUMMARY

Systems and methods are disclosed to provide the possibility to achieve the most exact color correspondence between the monitor representation and the representation produced by the output device upon output on the output device, especially a digital projector, of digital documents which were created with color management free applications.

### BRIEF DESCRIPTION OF THE DRAWINGS

Exemplary embodiments of the invention will be further described by way of the drawings. They show:

FIG. 1 the principal of the creation of a digital document by way of an application software on a computer;

FIG. 2 a block diagram of the output in accordance with an exemplary embodiment of the invention of a digital document on an output device; and

FIG. 3 a block diagram of relevant steps of an exemplary process in accordance with the invention.

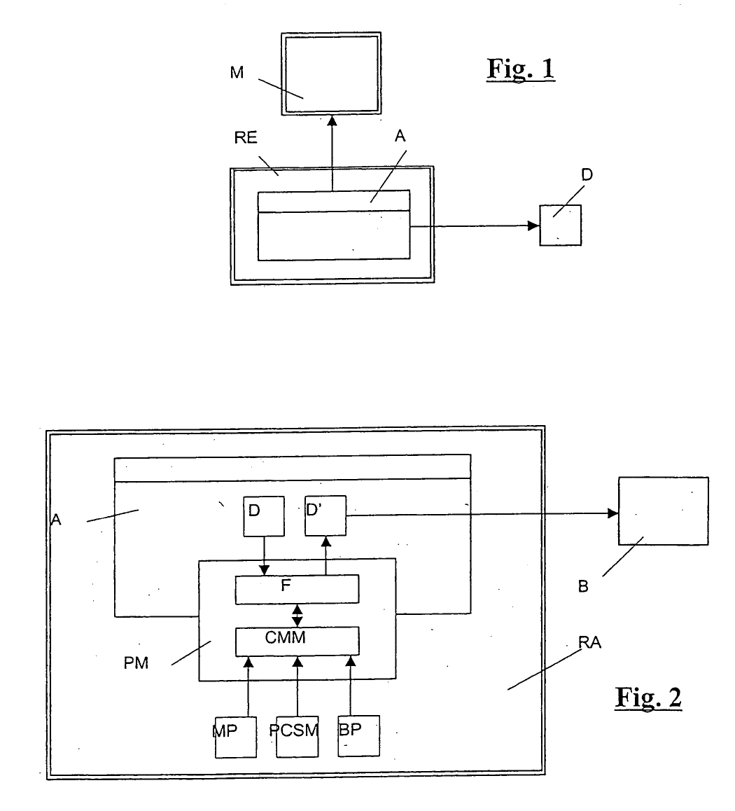

### DETAILED DESCRIPTION

The construction of a digital document D, for example a presentation to be presented later (to the output on an output device) is carried out on a creation computer RE using a color management free application A running thereon, for example Microsoft Power Point. A monitor M is connected to the creation computer RE on which the document D is visually represented during the construction. No Color Management of any sort is involved in the creation of the digital document D. The fully created digital document D is then in the form of a digital file.

The later presentation of the digital document D normally takes place by way of another computer through a suitable output device, typically a digital electronic projector (beamer) B, which is connected to and controlled by another computer referred to here as output computer RA (FIG. 2). The same Color Management free application A is installed on the output computer RA. The digital document D is therefore loaded in the usual manner into the application A (opened with the application A) and can be output in the usual manner on the projector B. The digital document D can also optionally be reproduced on a here not illustrated monitor which belongs to the output computer RA.

So far the invention fully corresponds to the known prior art, whereby the person skilled in the art does not require any further description.

As already mentioned above, the color impression of the visual representation of the digital document D produced by the digital projector B (or another output device) generally differs significantly from that reproduced on the monitor during the creation of the digital document. In order to now achieve an optimal color approximation with a Color Management free application A, a special program-module PM is installed according to an exemplary embodiment of the invention on the output computer RA, which makes the functionalities of a Color Management System available to the application A running thereon (FIG. 2). This program-module PM includes on the one hand a color transformation unit CMM and on the other hand interface functions F which allow it to access the digital document D loaded in the application A and to change it within the application A. Not further described routines are further included in the interface functions F by which ICC Profile files MP, PCS, BP stored in the output computer RA can be accessed, if necessary with the use of basis Color Management functions possibly made available by the operating system of the output computer RA.

The color transformation unit CMM is nothing else but a fast computer software, for example in the form of an independent dynamic program library (DLL) which includes the necessary mathematic algorithms for the color conversion. ICC profiles thereby make the corresponding parameters available and fill the mathematic algorithms with values. A commercially available Color Management Module can be used as the color transformation unit CMM, such as the color Management Module “LogoSync” developed by the above mentioned company Logo GmbH.

The program module PM can be an add on module (Add-In) for the application A, whereby the interface functions F form the software technological frame for the supplementary functions of the existing application A. The programming of this frame is thereby oriented on the specifications of the application A for the reduction and integration of add on modules (Add-Ins). Further details on the practical implementation of the Program-Module PM are described further below.

The process in accordance with an exemplary embodiment of the invention runs as follows:

An ICC device profile, in the following referred to as Monitor profile MP, is first produced by the Monitor M on which the digital document was created. This can be carried out in a generally known manner by way of commercially available measurement devices and associated profiling programs. Especially suited is the profiling software “EyeOne Match” distributed by the above already mentioned company Logo GmbH in connection with the spektrophotometer EyeOne distributed by the above already mentioned company Gretag-Macbeth AG. How this is carried out is described in detail in the documentation for this profiling software as well as, for example, in EP-A-1 150 159, the disclosure of which is hereby incorporated by reference in its entirety. The Monitor profile MP is then stored in the output computer RA as a file of standard format.

An output device profile BP is subsequently produced in analogous manner from the output device used, here for example the digital projector B, and also stored in the output computer RA. The production of a device profile for a digital projector is also described in all detail in EP-A-1 150 159.

The application A installed in the output computer RA is now started and the digital document D loaded into the application A or opened with the application A.

Instead of outputting the document D directly from the application A to the output device B, a color transformation is now first carried out by way of the program module PM, whereby the digital document D (or the data representing it) is recalculated according to the color management methods into a transformed digital document D′. This color transformed digital document D′ is then output by the application A to the output device, here the digital projector B.

As already mentioned, the color transformation is carried out by way of the program module PM. The interface functions F access the data of the digital document D in the application A and feed them to the color transformation unit CMM. Furthermore, the interface functions F load the monitor profile MP stored in the output computer RA, the output device profile BP stored thereon and the working color profile PCS (normally sRGB) stored thereon are made available by the operating system into the color transformation unit CMM. The actual color transformation (recalculation into the color space of the output device B) is carried out through the color transformation unit CMM which therefor uses the monitor profile MP as source profile and the output device BP as target profile. The recalculation itself is carried out in a generally known manner and possibly with consideration of the so called rendering intents (according to standard typically “perceptual”). The data of the recalculated or color transformed digital document D′ are fed by way of the interface functions F again to application A and there replace the data of the original digital document D. The output of the recalculated document D′ to the output device B is subsequently initiated by the interface functions F. The recalculation is preferably carried out respectively separately for each object included in the digital document D.

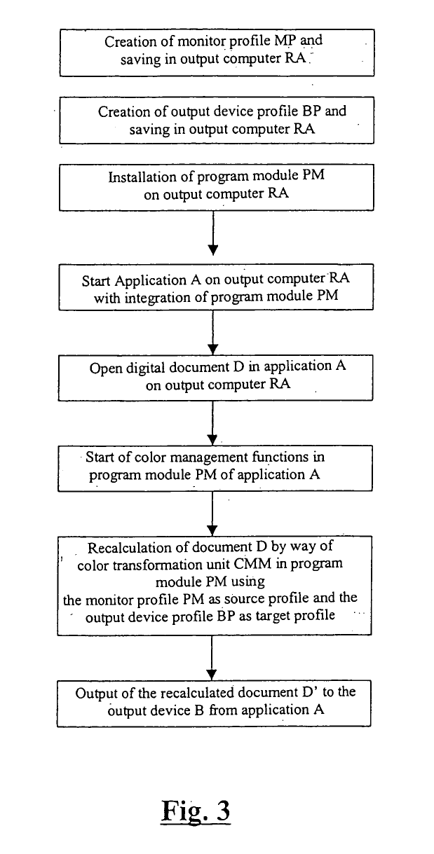

The above processing steps are again clearly combined in FIG. 3.

It is understood that for each combination of a specific monitor M and a specific output device, for example projectors B, respectively two specific device profiles MP and BP must be produced. Since especially with a digital projector the characteristic of the projection surface and the ambient light conditions are part of the color reproduction process, it is advantageous to produce several output device profiles BP for different constellations and to store them on the output computer RA, whereby then only the respectively suitable output device profile BP is used. When the monitor M and the output device B do not change, the associated device profiles MP and BP need of course only be produced once and can then be used for the true color output of different digital documents D.

The program module PM preferably makes an additional menu function available to the application A with which the user can make various selections and adjustments and start the color transformation and subsequent output of the color transformed digital document. For example, different working color spaces, different monitor profiles MP and different output device profiles BP can be selected in this manner, whereby it is of course a prerequisite that these color spaces and device profiles must be available on the output computer RA. A further menu point can be the selection of a rendering intent which is used, if the source color space (of the monitor M) is larger than the target color space (of the output device B), which means a color space adaptation (Gamut-Mapping) is required. Furthermore, a menu entry can also be provided which activates the recognition of ICC profiles embedded in image objects of the digital document D, so that those embedded profiles can be used by the color transformation.

In case of Microsoft Power Point as application software A, the implementation of the program module PM as add on module (Add In) is comparatively easy. Like all Microsoft Office applications of newer version, PowerPoint also includes the programming language Visual Basic for applications (VBA). Routines produced with this programming language (VBA-Scripts) can thereby be stored as modules and manually or automatically loaded as add-ins into the application and executed from there. VBA provides all objects, properties and methods of PowerPoint and allows their almost unlimited manipulation. Additional menus can be easily integrated into PowerPoint with VBA from which further functions implemented as VBA code can then be triggered. Especially, VBA provides the object “Presentation” which reproduces the loaded digital document with its incorporated objects and allows the access thereto. For example, the image data of the digital object can be copied with VBA into an intermediate memory and transferred from there to the color transformation unit CMM for recalculation. Another VBA routine thereafter reads the recalculated data from the color transformation unit CMM and writes them in suitable format back into the object “presentation”, so that the original data are replaced and a changed presentation is created.

The approach is analog in other applications, whereby however another programming language is possibly used. The principle functions and processes are however the same.

It is understood that the representation or general output of the digital document D on the output device can also be carried out by the same computer on which the digital document was created. In that case, the program module PM and the device profiles must of course be installed on the creation computer RE. The above description applies therefore in the same manner also for this case.

It is furthermore of course also possible to reproduce the digital document D on an output monitor connected, for example, to the output computer RA. In that case, this monitor would form the output device and an output monitor profile produced for this output monitor would have to be used as output device profile instead of the beamer profile BP. Analogous details apply when a printer is used as output device, for example.

It will be appreciated by those skilled in the art that the present invention can be embodied in other specific forms without departing from the spirit or essential characteristics thereof. The presently disclosed embodiments are therefore considered in all respects to be illustrative and not restricted. The scope of the invention is indicated by the appended claims rather than the foregoing description and all changes that come within the meaning and range and equivalence thereof are intended to be embraced therein.

1. Process for the output of a digital document on an output device controlled by an output computer, whereby the document to be output was produced with a color management free application installed on a creation computer with connected monitor, and whereby the color management free application is installed on the output computer and used by the output computer for output of the document to the output device, comprising:
producing an ICC-conform monitor profile for the monitor of the creation computer and storing the monitor profile on the output computer;
producing an ICC-conform output device profile for the output device and storing the output device profile on the output computer;
installing on the output computer a program module including a color transformation unit adapted for cooperation with the color management free application to make a color management functionality available to the application, whereby the program module can access the electronic document to be output and loaded in the application;
recalculating the electronic document in the color transformation unit into the color space of the output device by way of the color management functionality made available by the program module, using the stored monitor profile and the stored output device profile; and
outputting a recalculated document from the application to the output device.

2. The process according to claim 1, wherein the output device is a digital electronic projector.

3. The process according to claim 1, wherein the color management free application is used for creation of presentations.

4. The process according to claim 1, wherein the program module is constructed as a supplementary module for the color management free application.

5. The process according to claim 1, wherein the transformation of the document into the color space of the output device is carried out using color management principles set by the ICC.

6. The process according to claim 1, wherein the monitor profile is used as source profile and the output device profile is used as target profile for the transformation of the document by way of the color transformation unit.
